(19) United States
(12) Patent Application Publication
(10) Pub. No.: US 2006/0188029 A1
(43) Pub. Date: Aug. 24, 2006

(54) Sensor array with amplitude modulated output signal

(75) Inventor: Viktor Vladimirov Kassovski, Sofia (BG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MELEXIS NV, Leper (BE)

(21) Appl. No.: 10/532,378

(22) PCT Filed: Oct. 21, 2003
(86) PCT No.: PCT/IB03/04631

§ 371 Date: Mar. 20, 2006

(30) Foreign Application Priority Data
Oct. 23, 2002 (BG) 107215

(51) Int. Cl. H04L 27/00

(52) U.S. Cl. 375/259

(57) ABSTRACT

A sensing device in the form of a sensing array includes sensing elements on a first integrated circuit and means for processing the signals on a second integrated circuit. The output of the sensing elements is sampled, modulated on to a carrier signal and transferred from the first to second integrated circuits wherein it is demodulated and passed to a processing means.

The present invention relates to sensing devices and particularly arrays of such devices and in particular to a method of transferring signals generated by the individual array elements to an external processor or other such device.

A known arrangement for imaging utilises an array of sensitive elements implemented in the form of a silicon integrated circuit. The image is focussed onto the array and the individual signals generated by each of the sensitive elements are combined within a processing means to generate an image signal. Signals generated by the individual elements must be transferred to the processing means.

In a large array containing many sensitive elements a large number of connections may be needed between the sensitive elements and the processing means. Such a large number of connections can be a problem to implement and may become detrimental to the combined performance of the array and processing means. The routing of the signals between the sensitive elements in the array can occupy a significant amount of space and thereby create undesired spacing between sensitive elements thus degrading the image. Mutual coupling between connections and between connections and other signals can introduce error signals that may degrade the desired signal.

The semiconductor processes used to implement the array of sensitive devices are not always compatible or optimised for implementing the processing means. This is particularly so in the case of infrared, (IR), sensors. This dichotomy of objectives leads to conflicting requirements for the two parts of the system. The conventional solution to this problem is to provide the sensing means and the processing means on two separate integrated circuits. The first integrated circuit contains the array of sensitive devices and the second integrated circuit contains the interface and processing means. The large number of interconnections however associated with providing individual connections from the sensitive elements to the second chip means that there is a large manufacture cost for such a device and there is a question mark over assuring the reliability of such a large number of interconnections.

It is therefore an object of the present invention to provide an improved arrangement for transferring signals from within an array of sensitive elements to an associated processing means.

In accordance with the present invention therefore there is provided a method of transferring signals from a plurality of individual sensitive elements provided on a first integrated circuit to a processing means provided on a second integrated circuit comprising the steps of: sequentially sampling the output of a number of sensitive elements in a predetermined sequence to create a first signal; modulating the amplitude of a constant frequency signal to create a second signal; transmitting said second signal from said first integrated circuit to said second integrated circuit; demodulating said second signal to regenerate said first signal; and passing said regenerated first signal to said processing means.

Utilising such a method it is possible to transmit individual signals from individual elements in an array of sensitive elements to an external integrated circuit using a single sensing element signal transfer connection.

In accordance with a second aspect of the present invention there is an array of individual sensing elements provided on a first integrated circuit and suitable processing means for the output of said array of sensing elements provided on a second integrated circuit, said circuits being linked by a single conducting connection said first integrated circuit comprising in addition to said sensing elements: sampling means, for sequentially sampling the output of said sensing elements in a predetermined order to generate a first signal; signal generating means, for generating a carrier signal of a constant known frequency; modulation means for modulating said carrier signal with said first signal to generate a second signal; and transmission means for transmitting said second signal to the second integrated circuit, said second integrated circuit incorporating means for receiving said second signal, means for demodulating said second signal to regenerate said first signal and means for processing said regenerated first signal.

Preferably, the outputs of a first group of individual sensing elements may be sampled and then used to modulate a carrier signal of constant known frequency and the output of a second group of individual sensing elements is simultaneously sampled and used to modulate a carrier signal of a different constant known frequency, both modulated signals being simultaneously transmitted to said second integrated circuit and simultaneously demodulated after arriving at said second integrated circuit.

Most preferably, the outputs of several such groups of individual sensing elements are simultaneously sampled, modulated, transmitted and demodulated. In a particularly preferred embodiment the groups of sensing elements correspond to individual rows or columns in the sensing array, the sampling sequence within the group starting with the sensor at one end of said row or column and finishing with the sensor at the opposite end of said row or column. Preferably, each row or column is provided with a dedicated modulating means and the modulated signals are subsequently combined by a suitable combining means.

The sampling process may repeat instantly or alternatively there may be a predetermined delay between successive sampling sequences. Similarly the output of successive sensing elements may be sampled with substantially no time interval or with a finite preset time interval.

Preferably, each sensing element in a row or column is connected to a row or column output conductor by a switch. Sequential sampling of the outputs of the individual sensing elements is preferably carried out by sequentially connecting each sensing element to the row or column output conductor by closing each switch in turn. In an alternative embodiment wherein each sensor generates a differential output said sensing element may be connected by a pair of switches to a pair of output conductors the switches operated in the same manner as above.

Preferably, said second signal undergoes analogue to digital conversion and is subsequently demodulated as a digital process. Preferably, the signals resulting from the digital demodulation process are stored in registers for further image processing. Such digital processing may preferably be carried out by a microprocessor.

Preferably each carrier signal for each row or column or group of individual sensing elements has a different frequency. Most preferably, the carrier frequencies are determined such that any odd harmonics that may be generated during the modulation process using one carrier frequency are at frequencies that do not fall close to other carrier frequencies.

In a particularly preferred embodiment the carrier frequencies are produced by integer division from a single clock frequency signal. In such an embodiment a suitable clock frequency is 1 MHz and suitable integer division ratios are 18, 20, 22, 25, 28, 33, 40, and 50. Preferably a single clock signal generator or synchronisation signal generator is connected to both integrated circuits.

Preferably said sensing elements are IR (infrared) sensing elements although the invention can be embodied with any other radiation sensing elements or any other suitable sensing elements such as pressure, chemical or biological sensing elements disposed in an array.

In order that the invention is more clearly understood, it will now be further described with reference to the accompanying drawings in which:

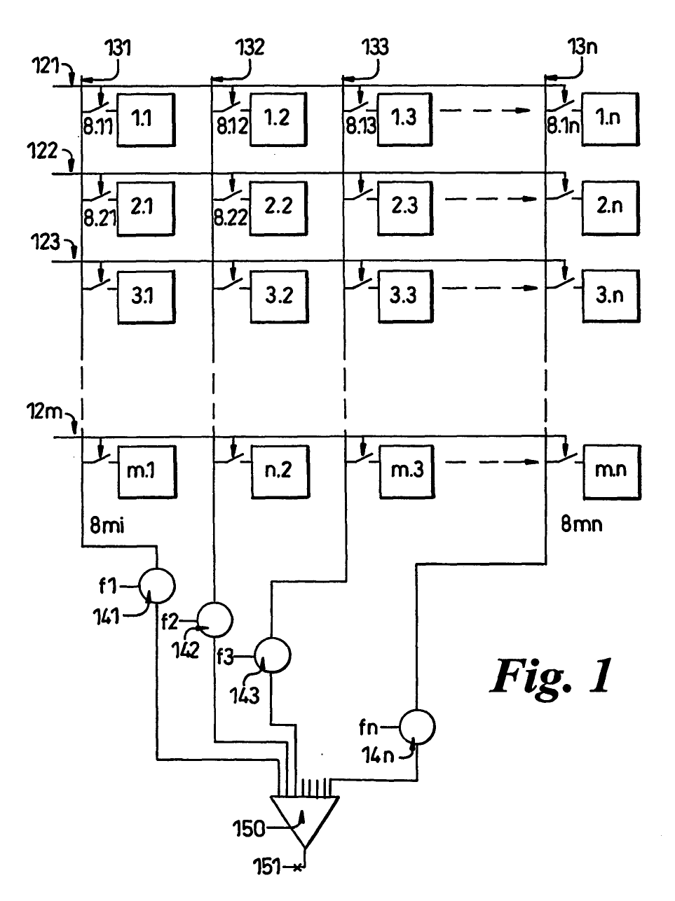

FIG. 1 is a block diagram of a sensor array incorporating sampling and modulation means according to the present invention;

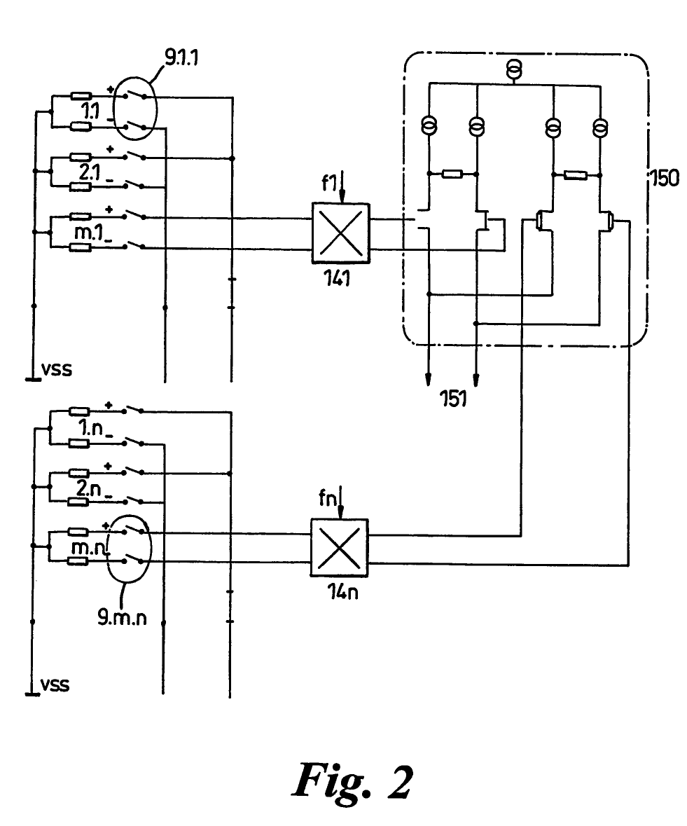

FIG. 2 is a more detailed view of an alternative modulation means for a sensor array according to the present invention;

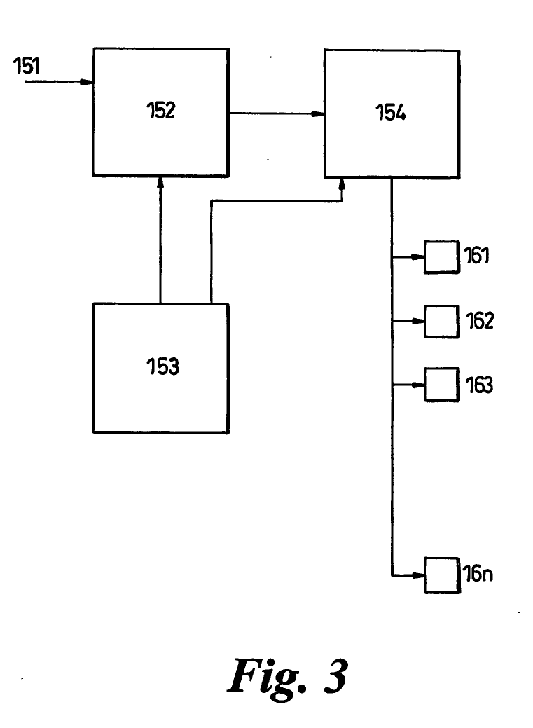

FIG. 3 is a block diagram showing a general arrangement of demodulation and processing means according to the present invention.

An embodiment of the invention will now be described with reference to the drawings by way of example.

The invention describes a sensing array wherein the sensing elements are provided on a first integrated circuit and means for processing the signals are provided on a second integrated circuit. The output of the sensing elements is sampled modulated on to a carrier signal and transferred from the first to the second integrated circuits wherein it is demodulated and passed to a processing means.

FIG. 1 shows a plurality of sensing elements arranged in a square array having n columns and m rows. A plurality of column output conductors 131, 132, 133, . . . 13n pass through the array in a first or column wise direction each column output conductor being associated with a column of sensing elements m.n in the array. A plurality of switch control conductors 121, 122, 123, . . . 12m pass through the array in a second or row wise direction each switch control conductor being associated with a row of sensing elements m.n in the array. Each of the sensing elements m.n is provided with a switch 811, . . . 8mn. The switch 811, . . . 8mn connects the output signal from the sensing element m.n to the associated column output conductor. Each of the switches 811, . . . 8mn is connected to and controlled by signals carried on the associated switch control conductors 121, 122, 123, . . . 12m. The signal carried by each switch control conductor 121, 122, 123, . . . 12m turns on all the switches 811, . . . 8mn in a particular row simultaneously. The signals on the switch control conductors 121, 122, 123, . . . 12m are arranged relative to one another such that each switch 811, . . . 8mn within each column is sequentially turned on for a time and that at any given time only one switch 811, . . . 8mn in each column is turned on. In this way each column output conductor 131, 132, 133, . . . 13n generates a first output signal consisting of sequential samples of the output of each of the sensing elements m.n in the column. When all the sensing elements m.n in each column have been sampled, the process is repeated. The sampling process is synchronised by means of synchronisation signals generated by a signal generator (not shown).

The column output conductors 131, 132, 133, . . . 13n are each connected to one of a plurality of modulators 141, 142, 143, . . . 14n. Each of said modulators modulates a carrier signal of a different frequency f1, f2, f3, . . . fn by the first output signal of each of the column output conductors 131, 132, 133, . . . 13n to generate a second output signal. The second output signals from said modulators 141, 142, 143, . . . 14n are combined in a combining means 150 into a transfer signal 151.

The carrier signal frequencies are all different and are determined such that any odd harmonics that may be generated during the modulation process using one carrier frequency are at frequencies that do not fall close to other carrier frequencies. To achieve this the carrier frequencies are produced by integer division from a single clock frequency signal. A suitable clock frequency is 1 Megahertz and suitable integer division ratios are 18, 20, 22, 25, 28, 33, 40 and 50. The signals on the switch control conductors are derived from the same single clock frequency. Additionally the synchronisation signal is generated from the same single clock frequency signal in a fixed relation to the switch control signals.

FIG. 2 shows a more detailed schematic of an alternative embodiment of the array. In this embodiment, each sensing element m.n element generates a differential signal. Said differential signal is connected through a pair of switches 911, . . . 9mn onto one of a plurality of pairs of output conductors. The differential signals on the pairs of column output conductors are modulated onto carrier signals and summed to form the transfer signal 151 whilst being maintained as differential signals. In all other aspects, this embodiment is the same as the first embodiment.

FIG. 3 shows an arrangement for demodulating the transfer signal and thereby generating a replica of the first output signals. The transfer signal 151 is connected to a filtering means 152 which separates the transfer signal into individual amplitude modulated signals at different discrete frequencies f1, . . . fn. The separated signals are individually passed to demodulation means 154. The demodulation means 154 demodulates the individual separated signals to form a replica of the first output signals from the column output conductors. To achieve this both the filtering means 152 and the demodulation means 154 use the same carrier frequencies as the modulators 141, . . . 14n, produced by integer division from a single clock frequency. The single clock frequency signal is the same frequency clock signal as used in the modulators 141, . . . 14n.

These carrier frequency signals are generated by generator means 153. The generator means 153 receives the same synchronisation signal as is received by the signal generator (not shown) of the first integrated circuit. This enables the elements of the transfer signal 151 to be accurately separated from one another and demodulated.

In a preferred embodiment the demodulation means 154 is embodied as an analogue to digital conversion means, operating by the method of converting the analogue transfer signal to a digital signal, converting the carrier signals to digital signals and carrying out the demodulation as a digital process. The signals resulting from the digital demodulation process are stored in registers 161, 162, 163, . . . 16n for further image processing. Typically, this further digital processing is carried out by a microprocessor.

Of course, it is to be understood that the invention is not to be restricted to the details of the above described embodiment which is described by way of example only.

1. A method of transferring signals from a plurality of individual sensing elements provided on a first integrated circuit to a processing means provided on a second integrated circuit comprising the steps of sequentially sampling the output of a number of sensing elements in a predetermined sequence to create a first signal, modulating the amplitude of a constant frequency signal to create a second signal, transmitting said second signal from said first integrated circuit to said second integrated circuit, demodulating said second signal to regenerate said first signal and passing said regenerated first signal to said processing means.

2. A method according to claim 1 wherein the outputs of a first group of individual sensing elements are sampled and are then used to modulate a carrier signal of constant known frequency and, the output of a second group of individual sensing elements is simultaneously sampled and used to modulate a carrier signal of a different constant known frequency, both modulated signals being simultaneously transmitted to said second integrated circuit and simultaneously demodulated after arriving at said second integrated circuit.

3. A method according to claim 2 wherein outputs of several such groups of individual sensing elements are simultaneously sampled, modulated, transmitted and demodulated.

4. A method according to claim 3 wherein the groups of sensing elements correspond to individual rows or columns in a sensing array, the sampling sequence within the group starting with a sensor at one end of the said row or column and finishing with the sensor at the opposite end of said row or column.

5. A method according to claim 4 wherein each row or column is provided with dedicated modulating means and the modulated signals are subsequently combined by a suitable combining means.

6. A method according to claim 1 wherein the sampling process is repeated instantly.

7. A method according to claim 1 wherein there is a predetermined delay between the successive sampling sequences.

8. A method according to claim 1 wherein said second signal undergoes analogue to digital conversion and is subsequently demodulated as a digital process.

9. A method according to claim 8 wherein signals resulting from a digital demodulation process are stored in registers for further image processing.

10. A method according to claim 4 wherein each carrier signal for each row or column or group of the individual sensing elements has a different frequency.

11. A method according to claim 10 wherein carrier frequencies are determined such that any odd harmonics that may be generated during the modulation process using one carrier frequency are at frequencies that do not fall close to other carrier frequencies.

12. A method according to claim 11 wherein carrier frequencies are produced by integer division from a single clock frequency signal.

13. A method according to claim 12 wherein a suitable clock frequency is 1 Megahertz and a suitable integer division ratios are one of 18, 20, 22, 25, 28, 33, 40 and 50.

14. A sensing device comprising an array of individual sensing elements provided on a first integrated circuit and processing means for the output of said array of said sensing elements provided on a second integrated circuit, said circuits being linked by a single conducting connection, said first integrated circuit comprising in addition to said sensing elements, sampling means for sequentially sampling the output of said sensing elements in a predetermined order to generate a first signal, signal generater means for generating a carrier signal of a constant known frequency, modulation means for modulating said carrier signal with said first signal to generate a second signal, and transmission means for transmitting said second signal to the second integrated circuit, said second integrated circuit incorporating means for receiving said second signal, means for demodulating said second signal to regenerate said first signal and means for processing said regenerated first signal.

15. A sensing device according to claim 14 wherein the outputs of a first group of individual sensing elements are sampled and are then used to modulate a carrier signal of constant known frequency and, the output of a second group of individual sensing elements is simultaneously sampled and used to modulate a carrier signal of a different constant known frequency, both modulated signals being simultaneously transmitted to said second integrated circuit and simultaneously demodulated after arriving at said second integrated circuit.

16. A sensing device according to claim 15 wherein outputs of several such groups of individual sensing elements are simultaneously sampled, modulated, transmitted and demodulated.

17. A sensing device according to claim 16 wherein the groups of sensing elements correspond to individual rows or columns in the sensing array, the sampling sequence within the group starting with the sensor at one end of the said row or column and finishing with the sensor at the opposite end of said row or column.

18. A sensing device according to claim 17 wherein each row or column is provided with dedicated modulating means and the modulated signals are subsequently combined by a suitable combining means.

19. A sensing device according to claim 14 wherein the sampling process is repeated instantly.

20. A sensing device according to claim 14 wherein there is a predetermined delay between the successive sampling sequences.

21. A sensing device according to claim 17 wherein each sensing element in a row or column is connected to a row or column output conductor by a switch.

22. A sensing device according to claim 21 wherein sequential sampling of the outputs of individual sensing elements is carried out by sequentially connecting each sensing element to the row or column output conductor by closing each switch in turn.

23. A sensing device according to claim 21 in which each sensor generates a differential output, each said sensing element being connected by a pair of switches to a pair of output conductors, these switches being closed in turn.

24. A sensing device according to claim 14 wherein said second signal undergoes analogue to digital conversion and is subsequently demodulated as a digital process.

25. A sensing device according to claim 24 wherein signals resulting from a digital demodulation process are stored in registers for further image processing.

26. A sensing device according to claim 24 in which digital processing is carried out by a microprocessor.

27. A sensing device according to claim 17 wherein each carrier signal for each row or column or group of the individual sensing elements has a different frequency.

28. A sensing device according to claim 27 wherein carrier frequencies are determined such that any odd harmonics that may be generated during the modulation process using one carrier frequency are at frequencies that do not fall close to other carrier frequencies.

29. A sensing device according to claim 28 wherein carrier frequencies are produced by integer division from a single clock frequency signal.

30. A sensing device according to claim 29 wherein a suitable clock frequency is 1 Megahertz and a suitable integer division ratios are one of 18, 20, 22, 25, 28, 33, 40 and 50.

31. A sensing device according to claim 26 wherein a clock signal generator or synchronisation signal generator is connected to both integrated circuits.

32. A sensing device according to claim 14 in which said sensing elements are IR (infrared) sensing elements.
